(19) United States
(12) Patent Application Publication
(10) Pub. No.: US 2025/0126227 A1
(43) Pub. Date: Apr. 17, 2025

(54) TWO-DIMENSIONAL VIDEO PRESENTED IN THREE-DIMENSIONAL ENVIRONMENT

(71) Applicant: Cisco Technology, Inc., San Jose, CA (US)

(72) Inventors: Sigurd Klasson, Oslo (NO); Fredrik Oledal, Hurdal (NO); Sebastian André Olsson, Oslo (NO)

(21) Appl. No.: 18/484,866

(22) Filed: Oct. 11, 2023

(51) Int. Cl. H04N 7/15; G06T 7/194; G06T 7/20; G06T 19/20

(52) U.S. Cl. CPC H04N 7/157; G06T 7/194; G06T 7/20; G06T 19/20; G06T 2219/2016

(57) ABSTRACT

The present technology provides a three-dimensional video conference experience using readily available cameras and two-dimensional video displays by inserting the two-dimensional video of a remote video conference participant into a three-dimensional environment, and by using visual cues to create the perception of depth for the two-dimensional video of a remote video conference participant.

### BACKGROUND

Video conferencing is a well established technology, but the experience is predominantly two-dimensional. Some proposals of holographic or other types of three-dimensional conferencing have been developed, but they usually require very expensive equipment on both the receiver side and transmitter side.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some aspects of this disclosure and are therefore not to be considered limiting of its scope. Other features, aspects, and advantages will become apparent from the description, the drawings and the claims.

FIG. 1A illustrates a virtual three-dimensional environment with a two-dimensional video of a remote video conference participant located within it according to some aspects of the present technology.

FIG. 1B illustrates a local video conference participant viewing a two-dimensional video of a remote video conference participant located within a virtual three-dimensional environment according to some aspects of the present technology.

FIG. 2A illustrates a picture of the three-dimensional environment displayed on the two-dimensional video display according to some aspects of the present technology.

FIG. 2B illustrates a picture of the three-dimensional environment displayed on the two-dimensional video display from a perspective taken from inside the local environment according to some aspects of the present technology.

FIG. 3 illustrates a system for carrying out some aspects of the present technology.

FIG. 4 illustrates an example routine for displaying a two-dimensional video of a remote video conference participant within a three-dimensional environment in accordance with some aspects of the present technology.

FIG. 5 illustrates an example routine for adjusting the three-dimensional environment based on at least one attribute of the two-dimensional video of the remote video conference participant.

FIG. 6 illustrates an example routine for rendering a three-dimensional model in the three-dimensional environment for interaction by the conference participants.

FIG. 7 shows an example of a system for implementing certain aspects of the present technology.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

In one aspect, a method includes receiving a video stream including a two-dimensional video of a remote video conference participant, and rendering a three-dimensional environment with the two-dimensional video of the remote video conference participant inserted into the three-dimensional environment, whereby the two-dimensional video of the remote video conference participant appears to a local video conference participant as if it were presented in three-dimensional video.

The method may also include where the video stream including the two-dimensional video of the remote video conference participant has been processed by a remote video conference participant device or video conferencing server to remove a background in the two-dimensional video of the remote video conference participant.

The method may also include further includes identifying a point of view of the local video conference participant, and displaying the three-dimensional environment relative to the point of view of the local video conference participant relative to a two-dimensional video display.

The method may also include where the three-dimensional environment includes a least one animated element, where the three-dimensional environment appears as live video.

The method may also include further includes analyzing the two-dimensional video of the remote video conference participant for at least one attribute, adjusting the three-dimensional environment based on the at least one attribute.

The method may also include where the three-dimensional environment is constructed from a plurality of layers.

The method may also include further includes receiving a three-dimensional model of an exhibit, displaying the three-dimensional model of the exhibit in the three-dimensional environment at a location in a foreground relative to the two-dimensional video of the remote video conference participant, receiving inputs effective to manipulate the three-dimensional model of the exhibit, and rotating and translating the three-dimensional model of the exhibit in the three-dimensional environment responsive to the inputs effective to manipulate the three-dimensional model of the exhibit. Other technical features may be readily apparent to one skilled in the art from the following figures, descriptions, and claims.

The method may also include further includes tracking a position of the local video conference participant in a physical environment before the two-dimensional video display, and translating the three-dimensional environment in response to a change in the position of the local video conference participant device in the physical environment. Other technical features may be readily apparent to one skilled in the art from the following figures, descriptions, and claims.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The present technology addresses the need in the art for providing a better video conferencing experience. More specifically, the present technology addresses a need in the art to provide a three-dimensional video conference experience using readily available cameras and two-dimensional video displays. The present technology provides an architecture for combining two-dimensional video with a three-dimensional environment to achieve a convincing three-dimensional effect.

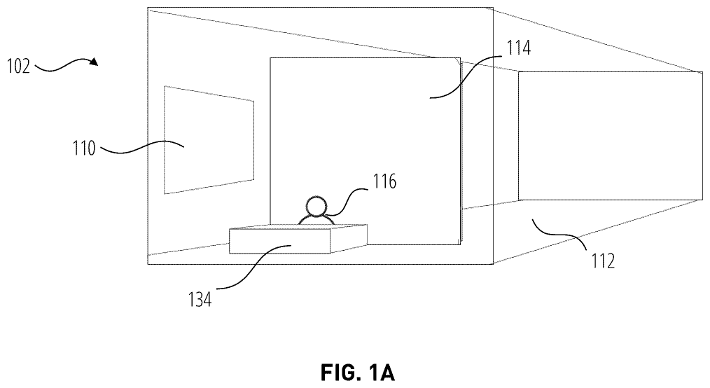

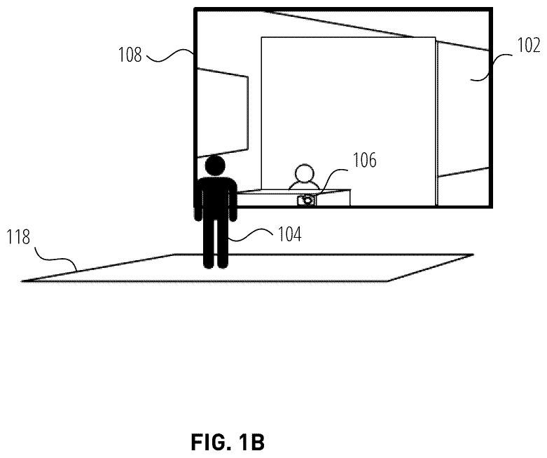

FIG. 1A illustrates a virtual three-dimensional environment with a two-dimensional video of a remote video conference participant located within it according to some aspects of the present technology. However, the accompanying drawing illustrates only some aspects of this present technology and is therefore not to be considered limiting of its scope.

The present technology provides a three-dimensional video conference experience using readily available cameras and two-dimensional video displays by inserting the two-dimensional video of a remote video conference participant into a three-dimensional environment, and by using visual cues to create the perception of depth for the two-dimensional video of a remote video conference participant.

For example, FIG. 1A illustrates a three-dimensional environment 102 with a two-dimensional video of the remote video conference participant 116 located in the three-dimensional environment 102. One way to think about the combination of these media sources is to think of the three-dimensional environment as a virtual background for the two-dimensional video of a remote video conference participant except that the two-dimensional video of the remote video conference participant is displayed in the three-dimensional environment instead of in the foreground.

As is common in traditional video conferences, meeting participants can take advantage of video processing technology to extract the video of the participant from their background and replace their background with a virtual background. A similar effect can be performed in the present technology except that instead of displaying the video of the meeting participant in the foreground and displaying a virtual background behind the video, the video of the meeting participant is displayed within a three-dimensional environment such that portions of the three-dimensional environment can appear to be in front of the two-dimensional video of the remote video conference participant, and some portions of the three-dimensional environment can appear in the background.

As seen in FIG. 1A the two-dimensional video of the remote video conference participant 116 is located in the three-dimensional environment 102. Some portions of the three-dimensional environment 102 appear in front of the remote video conference participant 116 such as a desk 134. While some portions of the three-dimensional environment 102 appear behind the remote video conference participant 116 such as a wall 114 and an animated background scene 112.

While the three-dimensional environment 102 is created in three-dimensions using an environment editor such as UNITY or UNREAL, it is still displayed on a two-dimensional video display. Furthermore, the video of the remote video conference participant is still two-dimensional. Accordingly, the present technology also utilizes cues to cause a local video conference participant to perceive that the video of the remote video conference participant is three-dimensional even though it is not.

For example, the three-dimensional environment 102 and the behavior of the system can be configured to aid in creating a perception to the local video conference participant that they are looking at an environment in three-dimensions and creating the perception that objects in the environment are also in three dimensions. Some cues for creating the perception of three-dimensions include:
“Monocular motion parallax” refers to the visual phenomenon where objects at different distances appear to move at different rates when observed through a single eye. It is based on the concept that as a viewer moves, the relative positions of objects in the scene change due to the difference in their distances from the viewer. The closer objects appear to move faster in the opposite direction of the viewer's movement, while objects farther away appear to move slower or in the same direction as the viewer's movement. This perceptual cue is often utilized in computer vision systems and depth perception analysis.
“Texture gradient” is a visual phenomenon that occurs when the apparent size and density of texture elements change as they recede into the distance. It is a depth cue used by humans to perceive depth and relative distance. In a texture gradient, the texture elements appear smaller, more closely packed, and less detailed as they move farther away from the observer's point of view. This perceived change in texture gradients provides important information about the relative depth and distance of objects in a scene. Texture gradients are commonly used in various disciplines, including computer vision, graphics, and psychology.
“Linear perspective” is a visual concept and technique used in art and design to create the illusion of depth and three-dimensional space on a two-dimensional surface. It relies on the observation that parallel lines, when viewed in a three-dimensional space, appear to converge at a vanishing point on the horizon. By applying linear perspective, artists and designers can accurately represent objects and scenes with depth and create a realistic sense of space. The technique involves drawing or representing objects with their lines or edges following the rules of convergence towards the vanishing point(s), thereby simulating the way objects appear in our visual perception of the real world.
“Retinal image size vs. actual size” refers to the comparison between the size of an object as it appears on the retina of the eye and its actual physical size in the external world. When we look at objects, the image of those objects is projected onto the retina, which is the light-sensitive tissue at the back of our eye. The size of the retinal image is determined by the distance between the object and the observer, as well as the size of the object itself. The retinal image size is not an exact representation of the actual size of the object. It can be influenced by various factors, such as the distance of the object from the observer, the focal length of the eye's lens, and the angle of viewing. Objects that are closer to the observer tend to produce larger retinal images, while objects that are farther away produce smaller retinal images. However, our visual system is perceptually skilled in interpreting and compensating for these variations. Through experience and depth perception cues, such as binocular disparity and motion parallax, our brain can estimate the actual size of an object based on its retinal image size. This ability allows us to make accurate judgments about the size, shape, and distance of objects in our environment. Understanding the relationship between retinal image size and actual size is crucial in fields such as visual perception, ophthalmology, and optics. It also plays a significant role in designing displays, visual simulations, and virtual reality systems, where accurately representing object sizes based on retinal image size is essential for creating realistic and immersive visual experiences.
“Relative size” is a visual cue used to perceive the size and distance of objects in relation to one another. It refers to the comparison of the apparent size of objects in a scene to estimate their relative sizes. When two objects are assumed to be similar in physical size but one appears smaller than the other, the smaller object is generally perceived as being farther away. The perception of relative size relies on the understanding that objects of the same size appear smaller when they are farther away from the observer and larger when they are closer. This size-distance relationship allows us to make judgments about the spatial arrangement of objects in our environment. By comparing the sizes of objects in a scene, our brain can assess their relative distance from the observer. Objects that are closer to us tend to have larger retinal images, while objects that are farther away produce smaller retinal images. Relative size is one of several depth cues that our visual system employs to create a sense of depth and perceive the spatial relationships between objects. Understanding how relative size affects our perception helps artists and designers depict depth and distance in their creations, and it is also a key consideration in the field of visual perception research.
“Occlusion” is a visual phenomenon that occurs when one object partially blocks or obstructs the view of another object. It refers to the situation where a closer object appears in front of and partially covers a more distant object, creating the perception of depth and spatial relationships. When an object occludes another, it serves as a visual cue for depth perception, signaling that the occluded object is located behind the occluding object. The occluded object may only be partially visible or completely hidden, depending on the extent of the occlusion. Occlusion is a fundamental depth cue that our visual system utilizes to understand the relative positions and distances of objects in our environment. It helps us to perceive the spatial arrangement of objects in three-dimensional space, enabling us to infer which objects are in the foreground and which are in the background. In computer graphics and computer vision, occlusion plays a crucial role in rendering realistic and believable scenes. Algorithms are used to simulate occlusion effects, allowing virtual objects to appear realistically in front or behind other objects based on their relative positions in the virtual 3D space. Overall, occlusion is an important visual cue that guides our perception of depth, enhances object recognition, and contributes to our understanding of the spatial relationships between objects.
“Aerial perspective,” also known as atmospheric perspective, is a perceptual phenomenon observed in landscapes or scenes when the appearance of objects changes as a result of the intervening atmosphere. It refers to the way distant objects appear less distinct, lighter in color, and less detailed compared to objects that are closer to the observer. Aerial perspective occurs due to the scattering and absorption of light by particles and molecules in the atmosphere, such as dust, water droplets, and pollution. These atmospheric effects create a hazy or foggy appearance, especially at greater distances. As a result, objects that are far away from the viewer exhibit reduced contrast, diminished color saturation, and a bluish or grayish tint. The concept of aerial perspective is often used in art to convey a sense of depth and distance. Artists intentionally incorporate these effects to create the illusion of vast spaces and to enhance the realism of their paintings or drawings. In addition, aerial perspective is also employed in various computer graphics applications to generate realistic virtual environments and enhance the perception of distance in computer-generated imagery. Understanding aerial perspective is valuable in fields such as landscape painting, visual effects, and virtual reality. By considering the atmospheric effects on distant objects, artists and designers can effectively create depth and realism in their visual compositions.
“Chromostereopsis” refers to a visual phenomenon in which certain color combinations appear to have a three-dimensional effect or create an illusion of depth when viewed by the human eye. It arises from the differential focusing characteristics of the eyes and the perception of color. The most commonly observed chromostereoptic effect occurs when red and blue tones are juxtaposed. When these colors are placed near each other, the red appears to come forward, while the blue appears to recede, creating the illusion of depth or a 3D effect. This effect is believed to be caused by the eyes' chromatic aberration, which refers to the eye's inability to focus all colors at the same point on the retina. Chromostereopsis is a subtle effect and its intensity can vary depending on factors such as the colors used, their brightness, and the surrounding context. It is often employed deliberately in various art forms, such as painting, graphic design, and visual media, to enhance depth perception and create visual interest.
“Parallax” refers to the apparent displacement or difference in the position of an object when viewed from different angles or perspectives. It is caused by the displacement between the observer's viewpoint and the object being observed. Due to the separation between the eyes, each eye provides a slightly different view of the same object. The difference in the images received by each eye allows the brain to perceive depth and form a three-dimensional understanding of the object's spatial position. In the context of photography or cinematography, parallax can refer to the phenomenon where a close or near object appears to move more significantly compared to objects farther away when the camera angle or perspective is changed. This effect is particularly noticeable when shooting with a handheld camera or when capturing a moving subject.
“Keystoning” also known as perspective distortion, occurs when a rectangular object or structure, such as a building or a projection screen, is not perfectly aligned with the camera lens. As a result, the object appears to have a trapezoidal or distorted shape in the captured image. This distortion is particularly visible when the camera is tilted upward or downward, causing vertical lines to converge or diverge.

While some of these cues can be applied in a static environment, monocular motion parallax requires motion that can be inserted into the three-dimensional environment in at least two ways. First, the three-dimensional environment can include animations. For example, three-dimensional environment 102 can include an animated window scene 110 and an animated background scene 112. The animated window scene 110 can provide an animation of a view out a window that could include people walking, animals moving, or landscapes. The animated background scene 112 can include motion such as people walking or other scenes. In both instances, motion can facilitate the monocular motion parallax effect. These animations can also make the scene more realistic.

While three-dimensional environment 102 has been described with two types of animated scenes, it will be appreciated that this is just by way of example. Likewise, the presence of the desk 134 and wall 114 are not required.

FIG. 1B illustrates a local video conference participant viewing a two-dimensional video of a remote video conference participant located within a virtual three-dimensional environment according to some aspects of the present technology. However, the accompanying drawing illustrates only some aspects of this present technology and is therefore not to be considered limiting of its scope.

FIG. 1B illustrates the three-dimensional environment 102 as displayed on a two-dimensional video display 108. Additionally, the local video conference participant 104 stands before the two-dimensional video display 108 in local environment 118. The local environment 118 is the physical environment in which the local video conference participant 104 is present. The local video conference participant 104 can move around the local environment 118.

The present technology can use face detection and tracking to determine the head position of the local video conference participant 104. As the local video conference participant's 104 relative position changes, the two-dimensional video display 108 changes the rendering of the three-dimensional environment 102 displaying the video capture device 106. Accordingly, a three-dimensional effect can also be created in response to the changes in the rendering of the three-dimensional environment 102 in response to movement by local video conference participant 104 within the local environment 118.

For example, as a local video conference participant 104 moves throughout the local environment 118, the two-dimensional video display 108 needs to respond by adjusting the display of the three-dimensional environment to match the local video conference participant 104's point of view. In order to accommodate the changing point of view, objects in the foreground appear to be displaced by a greater amount than objects in the background through a parallax effect. Additionally, the changes in the apparent keystoning of objects in the foreground changes greater than objects in the background.

Another technique that can be used is eye tracking with focus areas. The three-dimensional environment 102 may appear more realistic if only the areas that the eyes are looking at are in clear focus. While this technique is sometimes used to save processing resources, it also mimics a real world environment where the eyes can only have portions of the environment in focus at any time.

Another technique that can help give the three-dimensional environment 102 a feel or more realistic depth when displayed on the two-dimensional video display 108 is to mount the two-dimensional video display 108 in a recessed frame or in a wall cavity. This technique utilizes actual depth from the real-world environment to enhance the rendered depth in the three-dimensional environment 102.

Another technique that can help give the three-dimensional environment 102 a feel or more realistic depth when displayed on the two-dimensional video display 108 is to match or adjust the lighting of the three-dimensional environment 102 to the lighting of the video of the remote video conference participant. In some aspects, artificial shadows of the remote video conference participant can also be created to further give the impression that the remote video conference participant is displayed in three dimensions.

Another technique that can help give the three-dimensional environment 102 a feel of more realistic depth when displayed on the two-dimensional video display 108 is to place a three-dimensional object in front of the two-dimensional video of a remote video conference participant such that it can appear as if the remote video conference participant is manipulating the three-dimensional object. In reality, the remote video conference participant can use a mouse or hand tracking to provide inputs to manipulate the three-dimensional object, but the presence of the object can enhance the perception that the remote video conference participant is present in the scene as a three-dimensional rendering.

Collectively, all of these techniques allow a three-dimensional environment 102 displayed on the two-dimensional video display 108 to appear more realistic. The culmination of these techniques is that objects in the three-dimensional environment 102 appear to be three-dimensional, including the two-dimensional video of the remote video conference participant. The local video conference participant 104 can perceive that the two-dimensional video of a remote video conference participant is in three dimensions even though the local video conference participant 104 does not see different views of the video of the remote video conference participant as the local video conference participant 104 changes their point of view.

The perception that the two-dimensional video of a remote video conference participant is in three dimensions can further be improved through the use of various artificial intelligence techniques which can add depth to two-dimensional video such that aspects of parallax can be applied to the object. In some instances, the remote video conference participant can have captured a three-dimensional model of themselves, which artificial intelligence tools can use to fill in views of the remote video conference participant that are not captured in the two-dimensional video of a remote video conference participant.

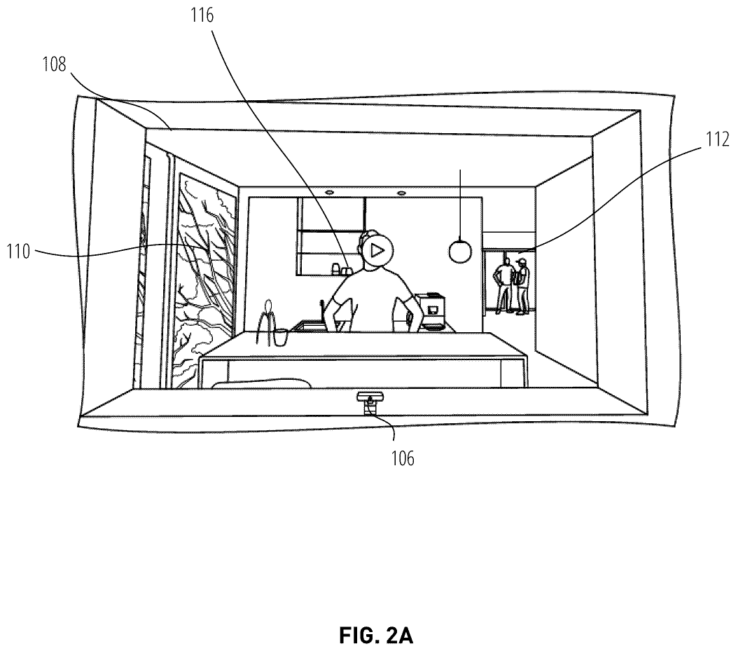

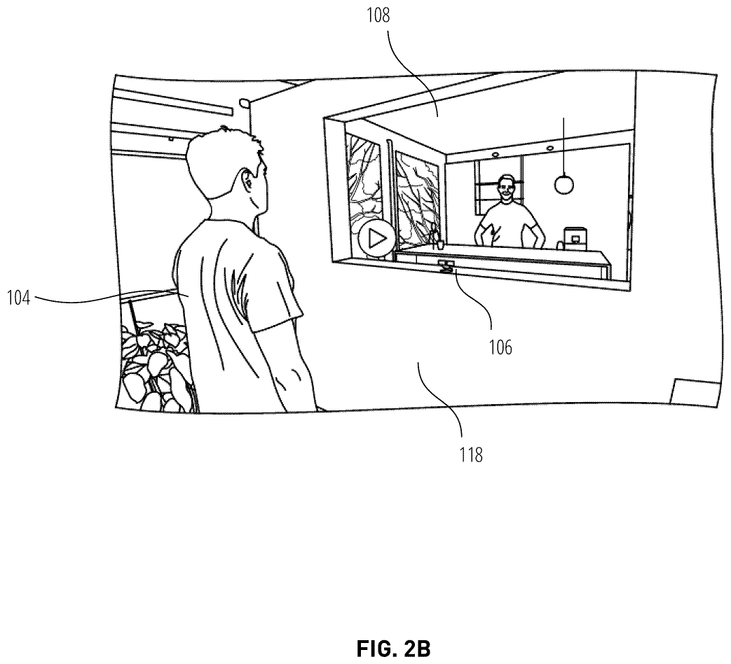

FIG. 2A illustrates a picture of the three-dimensional environment displayed on the two-dimensional video display according to some aspects of the present technology. However, the accompanying drawing illustrates only some aspects of this present technology and is therefore not to be considered limiting of its scope.

As illustrated in FIG. 2A the remote video conference participant 116 is presented in the middle of the three-dimensional environment. The three-dimensional environment is enhanced by the animated window scene 110 and the animated background scene 112. Further, the three-dimensional environment appears to have more depth because it is recessed in a frame.

FIG. 2B illustrates a picture of the three-dimensional environment displayed on the two-dimensional video display from a perspective taken from inside the local environment according to some aspects of the present technology. However, the accompanying drawing illustrates only some aspects of this present technology and is therefore not to be considered limiting of its scope.

FIG. 2B illustrates the local video conference participant 104 in the local environment 118 looking at the two-dimensional video display 108 displaying the three-dimensional environment with two-dimensional video of the remote video conference participant within it.

A video capture device 106 can capture video of the local video conference participant 104 and analyze the video to track the video capture device 106 throughout the local environment 118 in order to adjust the perspective and point of view of the three-dimensional environment so that the local video conference participant 104 has the impression that they are looking through a window at a live three-dimensional environment.

Of course, the video capture device 106 can also be used to transmit video of the local video conference participant 104 to a video conferencing service for viewing by the remote video conference participant.

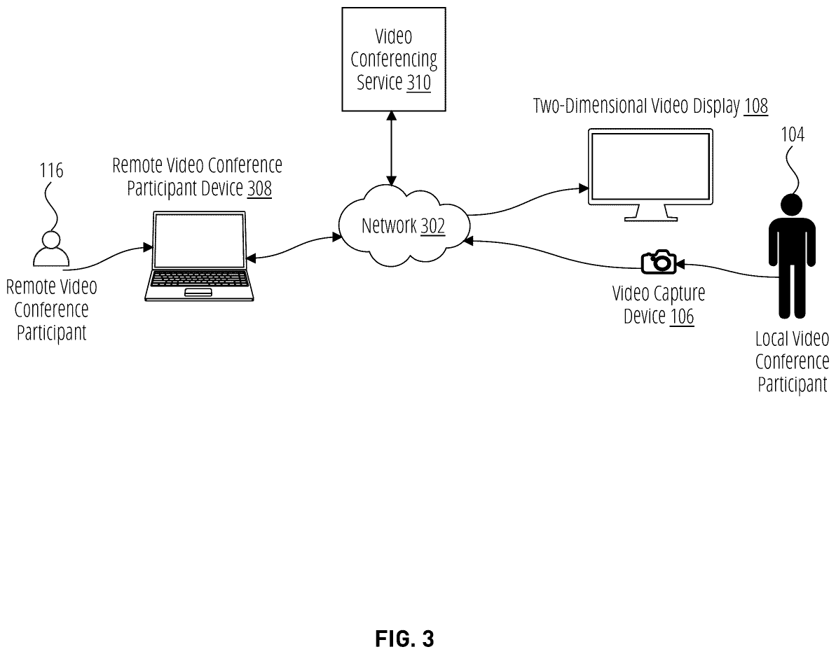

FIG. 3 illustrates a system for carrying out some aspects of the present technology. However, the accompanying drawing illustrates only some aspects of this present technology and is therefore not to be considered limiting of its scope.

As illustrated in FIG. 3, a local video conference participant 104 and a remote video conference participant 116 are engaged in a video conference hosted by a video conferencing service 310.

The remote video conference participant 116 engages with the video conference using their remote video conference participant device 308. The remote video conference participant device 308 can be a laptop or other personal computer, a mobile computing device, or dedicated video conferencing equipment such as a camera and a display in an office or conference room. In some aspects of the present technology the camera that is part of the remote video conference participant device 308 captures two-dimensional video.

The remote video conference participant device 308 or the video conferencing service 310 can be configured to separate video of the remote video conference participant 116 from a background in video frames captured by the remote video conference participant device 308 to yield the two-dimensional video of the remote video conference participant for distribution to the two-dimensional video display 108.

The video conferencing service 310 can transmit the two-dimensional video of the remote video conference participant over the network 302 to video conferencing equipment of the side of the local video conference participant 104. FIG. 3 illustrates this video conferencing equipment as the two-dimensional video display 108 for displaying the three-dimensional environment with two-dimensional video of the remote video conference participant placed within the three-dimensional environment, and video capture device 106. In some aspects, the two-dimensional video display 108 can be mounted in a recessed frame in a meeting room. However, the two-dimensional video display 108 and the video capture device 106 can be integrated into a single device, or even be part of a personal computer, laptop, or portable computing device. Some configurations of these devices are better at producing the perception of the three-dimensional conference, but the various techniques described herein are generally suitable to achieve the intended effect whether the three-dimensional environment is displayed on a laptop display, or the display is mounted within the recessed frame.

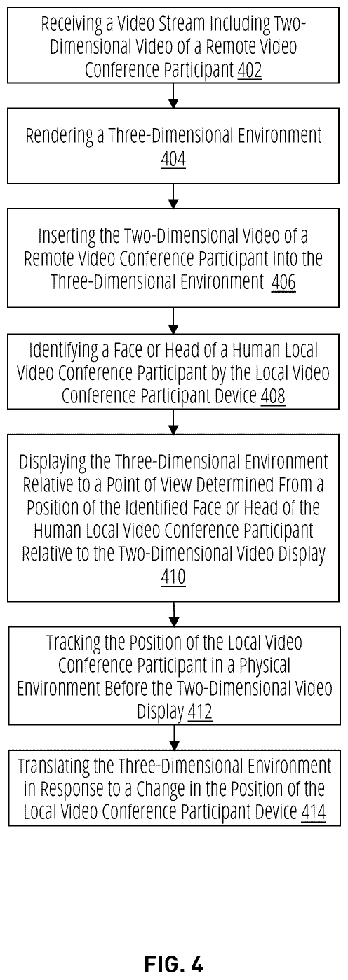

FIG. 4 illustrates an example routine for displaying a two-dimensional video of a remote video conference participant within a three-dimensional environment in accordance with some aspects of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence. For example, some blocks of the method can be performed by the video conferencing service 310, the remote video conference participant device, or two-dimensional video display.

According to some examples, the method includes receiving a video stream including two-dimensional video of a remote video conference participant at block 402. For example, the video conferencing service 310 illustrated in FIG. 3 may receive a video stream including two-dimensional video of a remote video conference participant. In some embodiments, the video stream including the two-dimensional video of the remote video conference participant has been processed by a remote video conference participant device 308 to remove a background in the two-dimensional video of the remote video conference participant. In some embodiments, the video stream including the two-dimensional video of the remote video conference participant can be processed by the video conferencing service 310 to remove the background in the two-dimensional video of the remote video conference participant.

According to some examples, the method includes rendering a three-dimensional environment at block 404. For example, the video conferencing service 310 illustrated in FIG. 3 may render a three-dimensional environment using a three-dimensional rendering engine such as UNITY or UNREAL. The method also includes inserting the two-dimensional video of a remote video conference participant into the three-dimensional environment at block 406. For example, the video conferencing service 310 illustrated in FIG. 3 may insert the two-dimensional video of a remote video conference participant into the three-dimensional environment. Alternatively, in some embodiments, the functions addressed with respect to block 404 and block 406 can be handled by the two-dimensional video display or other local video conference participant-side conferencing equipment.

As addressed above, the three-dimensional environment is constructed to take advantage of various effects that can provide the perception to the local video conference participant that they are looking into a three-dimensional environment that includes a three-dimensional representation of the remote video conference participant even though the remote video conference participant is presented in a two-dimensional video stream. In some examples, the three-dimensional environment includes a least one animated element. The animated element can provide further cues of a three-dimensional environment by utilizing motion to demonstrate monocular motion parallax and other effects. The three-dimensional environment can appear as a live video. In some embodiments, the three-dimensional environment can be constructed from a plurality of layers where some layers include static objects, and other layers include the two-dimensional video of a remote video conference participant, animated scenes, etc.

According to some examples, the method includes identifying a face or head of a human local video conference participant by the local video conference participant device at block 408. For example, the video conferencing service 310 illustrated in FIG. 3 may identify a face or head of a human local video conference participant by the local video conference participant device. The method further includes displaying the three-dimensional environment relative to a point of view determined from a position of the identified face or head of the human local video conference participant relative to the two-dimensional video display at block 410. For example, the two-dimensional video display 108 illustrated in FIG. 1B may display the three-dimensional environment relative to a point of view determined from a position of the identified face or head of the human local video conference participant relative to the two-dimensional video display. Collectively these functions can be performed by a combination of the video capture device 106 and video conferencing service 310 wherein the video capture device 106 can capture video of the local video conference participant 104 and send it back to the video conferencing service 310 which can process the video to determine the point of view of the local video conference participant 104 and adjust the rendering of the three-dimensional environment accordingly. In some embodiments, the video capture device 106 might have algorithms to perform the identifying the face or head and for tracking the local video conference participant 104 and can provide these processed results to the video conferencing service 310. Alternatively, such as when the three-dimensional environment is rendered by the two-dimensional video display 108, the two-dimensional video display 108 can perform the functions of deriving the point of view of the local video conference participant 104 (or may receive such information from the video capture device 106) and adjust the rendering of the three-dimensional environment accordingly.

The three-dimensional environment is displayed by the two-dimensional video display 108. As addressed above, the two-dimensional video window is presented in a frame. The frame is a physical frame that provides depth to the screen and aids in a perception of parallax by the local video conference participant. The two-dimensional video window presented in the frame creates an impression of peering into the three-dimensional environment through a window.

According to some examples, the method includes tracking the position of the local video conference participant in a physical environment before the two-dimensional video display at block 412. For example, the video conferencing service 310 illustrated in FIG. 3 may track the position of the local video conference participant in a physical environment before the two-dimensional video display. The tracking the position of the local video conference participant includes tracking the face or head of the human local video conference participant as the human local video conference participant moves in the physical three-dimensional environment. As noted above with the initial display of the three-dimensional environment at block 410, the tracking can be performed by the video capture device 106.

According to some examples, the method includes translating the three-dimensional environment in response to a change in the position of the local video conference participant device at block 414. For example, the video conferencing service 310 or the two-dimensional video display 108 illustrated in FIG. 3 may translate the three-dimensional environment in response to a change in the position of the local video conference participant device. In this way, the three-dimensional environment appears more realistic as the environment is translated and the rendering is refreshed to continue to reflect the local video conference participant 104's point of view into the three-dimensional environment. For example, as the local video conference participant moves closer to the two-dimensional video display, the local video conference participant will be able to see a wider view of the three-dimensional environment, and the keystoning of objects rendered in the three-dimensional environment can be adjusted to adapt to the local video conference participants point of view.

As addressed above the two-dimensional video display can give the impression, to the local video conference participant, that they are looking through a ‘window’ into the three-dimensional environment. The changing of the field of view and the adjusting of the keystoning of objects helps to provide this impression, as does putting the two-dimensional video display in a recessed frame. Additionally, the present technology can also be responsive to light source effects from the local environment spilling through the ‘window’ into the three-dimensional environment. For example, the video capture device 106 or other sensors (ambient light sensors) can detect the amount of light in the local environment and render effects in the three-dimensional environment to further aid in the illusion that the two-dimensional video display is a window into the three-dimensional environment. In some embodiments, the local video conference participant can even shine a flashlight into the three-dimensional environment, and the effects of the flashlight can be rendered in the three-dimensional environment.

In some embodiments, the three-dimensional environment can host more than one video stream of remote video conference participants. For example, the three-dimensional environment can be generated to account for multiple remote video conference participants each displayed in two dimensions. The streams of the two-dimensional videos of the remote video conference participants can be placed at locations in the environment that provide a perception that both two-dimensional video streams are in three dimensions.

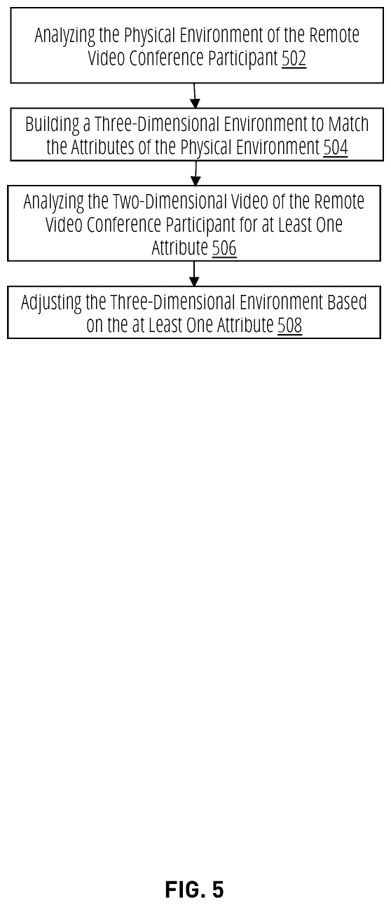

FIG. 5 illustrates an example routine for adjusting the three-dimensional environment based on at least one attribute of the two-dimensional video of the remote video conference participant. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

One aspect of facilitating the perception that the two-dimensional video of the remote video conference participant is displayed in three dimensions just as the rest of the three-dimensional environment is to make the two-dimensional video of the remote video conference participant appear like it is part of the three-dimensional environment. In order to do this well, there are some attributes such as lighting direction, light color, light saturation, shadows, etc. that are present in the two-dimensional video of the remote video conference participant that should be compatible with the three-dimensional environment.

One method that can be used to make the two-dimensional video of the remote video conference participant look more natural in the virtual background is to place the two-dimensional video of the remote video conference participant in a virtual environment that matches the remote video conference participant's physical environment as much as possible.

According to some examples, the method includes analyzing the physical environment of the remote video conference participant at block 502. For example, the video conferencing service 310 illustrated in FIG. 33, can analyze the physical environment of the remote video conference participant.

More specifically, prior to a video conference, the remote video conference participant can operate their remote video conference participant device 308 or other environment-capturing equipment to capture images and depth attributes of their physical environment. At a minimum, this can include using the remote video conference participant device 308 that will be used to capture the video for a video conference to record images of the physical environment of the remote video conference participant. In some embodiments, multiple images, from different angles, can be taken of the physical environment. Many digital cameras and smart phones can be configured to collect detailed motion data from accelerometers and gyroscopes in the device that can be used to determine the relative position of the camera between a first image and a second image. Preferably, these images would not include the remote video conference participant. Additionally, if the remote video conference participant has access to an ambient light sensor, a lidar or radar device, or an ultrasound emitting and receiving device, these devices can be used to capture additional data about the physical environment. While these devices might seem specialized, many of these sensors are available on some mobile devices and laptops. Such sensors can be used to measure the light level and light temperature in the physical environment and to create a 3D point cloud of the physical environment which allows for accurate measurements of the physical environment.

The video conferencing service 310 can receive the images, lighting attributes, and depth attributes of the physical environment from the remote video conference participant device 308 and can analyze this data to recognize objects in the physical environment. In some embodiments, the video conferencing service 310 can use object recognition technologies and other artificial intelligence image analysis tools to identify objects such as walls, desks, lighting sources, etc.

According to some examples, the method includes building a three-dimensional environment to match the attributes of the physical environment at block 504. For example, the video conferencing service 310 illustrated in FIG. 3 may build a three-dimensional environment to match the attributes of the physical environment. The building of the three-dimensional environment can be done automatically, or with the participation of the remote video conference participant. One benefit of the present technology is that it provides a more realistic video conferencing experience than other methods and a key aspect of this is to ensure that the two-dimensional video of the remote video conference participant looks well placed in the three-dimensional environment, and this can be achieved by matching attributes of the physical environment of the remote video conference participant to the three-dimensional environment as much as possible.

Accordingly, the video conferencing service 310 can build a three-dimensional environment based on the attributes of the local environment. The video conferencing service 310 can be configured with building blocks for a basic environment. For example, the video conferencing service 310 can be configured with several styles of windows, multiple styles of desks, conference tables, seating, book cases, lighting fixtures, doors, flooring, etc. that are common in a physical environment used for video conferencing. The video conferencing service 310 can select options that best match the objects in the physical environment. For example, if the physical environment includes a desk, the three-dimensional environment can include a desk, that may or may not look the same as the desk in the physical environment.

Since the environment is being created, clutter from the physical environment does not need to be rendered.

Some key aspects to be accounted for when building the three-dimensional environment are objects that occlude a portion of the remote video conference participant, light sources, shadows, and reflective surfaces. Accordingly, the video conferencing service 310 can place light sources such as windows and lights in appropriate locations, draw shadows of the remote video conference participant and objects that are rendered in the environment, etc. The light sources and shadows can be dynamic as well so that they can be adjusted, as addressed below.

In some embodiments, the three-dimensional environment can also be embellished to include objects that are not in the physical environment. For example, the remote video conference participant can add optional features to decorate the three-dimensional environment to add their own personalization. Additionally, the video conferencing service 310 can add additional areas to the three-dimensional environment such as background areas with animation, or add animation to scenes outside of windows, etc.

During a video call, according to some examples, the method includes analyzing the two-dimensional video of the remote video conference participant for at least one attribute at block 506. For example, the video conferencing service 310 illustrated in FIG. 3 may analyze the two-dimensional video of the remote video conference participant for at least one attribute. The at least one attribute can pertain to a direction or intensity of a light source, or color temperature of the light on the remote video conference participant, etc. illuminating the remote video conference participant.

According to some examples, the method includes adjusting the three-dimensional environment based on the at least one attribute at block 508. For example, the video conferencing service 310 illustrated in FIG. 3 may adjust the three-dimensional environment based on the at least one attribute. The adjusting the three-dimensional environment can include adjusting the lighting of the three-dimensional environment to originate from a similar direction and adjusting the three-dimensional environment for a light saturation that appears natural for the intensity of the light source. For example, a light or window can be dynamically adjusted to match the lighting on the remote video conference participant. In another example, shadows can be rendered to make it appear as if the remote video conference participant is casting a natural-looking shadow based on the lighting in the three-dimensional environment. In another example, the video conferencing service 310 can detect that a light that was present in the images received during the set of the three-dimensional environment is on or off and the video conferencing service 310 can also turn that light on or off. Additionally, if the light is a desk light and it is not longer present, the video conferencing service 310 can dynamically remove the light from the three-dimensional environment.

The adjusting the three-dimensional environment can also include adjusting the color temperature of the three-dimensional environment to be more similar to the color temperature illuminating the remote video conference participant.

In some embodiments, the adjusting the three-dimensional environment includes selecting a three-dimensional environment from a collection of three-dimensional environments that is compatible with the attribute. For example, there might be several possible three-dimensional environments that can be used with the video conferencing service 310 and a three-dimensional environment that best matches attributes of the remote video conference participant can be selected. For example, the remote video conference participant might regularly participate in conferences from multiple locations including their office, a conference room, and home. the video conferencing service 310 can detect which environment the remote video conference participant is in and can automatically place the remote video conference participant in an appropriate pre-configured environment that corresponds to the current physical environment of the remote video conference participant.

In some embodiments, the remote video conference participant may participate in a video conference in a physical environment that has not been previously analyzed and for which no corresponding three-dimensional environment has been configured. In such embodiments, the present technology can provide generic environments. The video conferencing service 310 can determine that the remote video conference participant is in an unknown environment and can dynamically select the best matching generic environment and can continuously adjust the environment throughout the video conference to improve the lighting characteristics or add light sources as they are discovered.

In some embodiments, such as when there are multiple remote video conference participants, the locations of the remote video conference participants in the three-dimensional environment can be selected to best match the lighting on the respective remote video conference participants.

In some embodiments, the three-dimensional environment can host more than one video stream of remote video conference participants. For example, the three-dimensional environment can be generated to account for multiple remote video conference participants each displayed in two dimensions. The streams of the two-dimensional videos of the remote video conference participants can be placed at locations in the environment that provide a perception that both two-dimensional video streams are in three dimensions.

One of the remote video conference participants can select a virtual environment so that all remote video conference participants can appear together in the same space. While the three-dimensional environment probably won't match either user's physical environment, the three-dimensional environment can be configured with lighting sources that mimic each remote video conference participant's physical environment lighting conditions. For example, the amount of light, color temperature of the light, shadows, etc. can be adjusted for each participant individually.

In some embodiments, both a remote video conference participant and a local video conference participant can appear in the same environment. In such embodiments, the local video conference participant can create a three-dimensional environment based on an analysis of their local environment, similar to that described above for a remote video conference participant in their physical environment. The local video conference participant can then appear to the remote video conference participant in either two-dimensional video with their real environment or as two-dimensional video in the three-dimensional environment the local video conference participant has constructed. At the same time, the remote video conference participant can appear in the three-dimensional environment the local video conference participant has constructed. Once again, aspects of the three-dimensional environment can be automatically varied by the video conferencing service 310 to adjust the amount of light, color temperature of the light, shadows, etc. for each participant individually.

Additionally, while a video conference participant will look most natural in a three-dimensional environment that most closely approximates their physical surroundings, it can be that the conference participant that is remote from them can pick the surroundings in which they see their conference counterpart (i.e., a local video conference participant chooses the environment for the remote video conference participants). Since the most important view in a video conference is not a user's self-view, but rather the view of how participants of the conference see their remote video conference participants. For example, it might make a conference participant more relaxed to see their remote video conference participants in an environment that is more comfortable to the local video conference participant.

In the embodiments addressed above, the present technology can either put all conference participants in the same environment or allow the local video conference participant to choose a three-dimensional environment for their remote video conference participants.

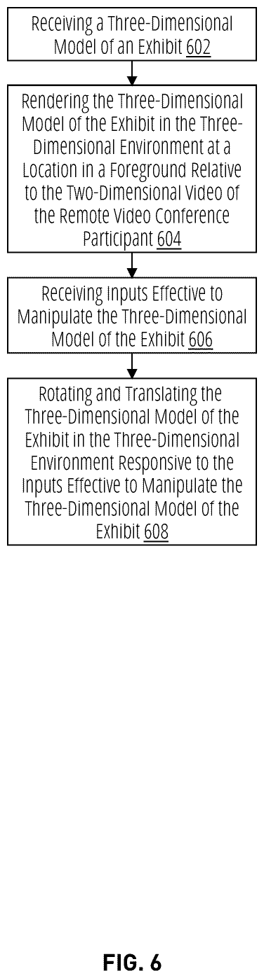

FIG. 6 illustrates an example routine for rendering a three-dimensional model in the three-dimensional environment for interaction by the conference participants. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes receiving a three-dimensional model of an exhibit at block 602. For example, the video conferencing service 310 illustrated in FIG. 3 may receive a three-dimensional model of an exhibit.

According to some examples, the method includes rendering the three-dimensional model of the exhibit in the three-dimensional environment at a location in a foreground relative to the two-dimensional video of the remote video conference participant at block 604. For example, the video conferencing service 310 illustrated in FIG. 3 may render the three-dimensional model of the exhibit in the three-dimensional environment at a location in a foreground relative to the two-dimensional video of the remote video conference participant.

According to some examples, the method includes receiving inputs effective to manipulate the three-dimensional model of the exhibit at block 606. For example, the video conferencing service 310 illustrated in FIG. 3 may receive inputs effective to manipulate the three-dimensional model of the exhibit.

According to some examples, the method includes rotating and translating the three-dimensional model of the exhibit in the three-dimensional environment responsive to the inputs effective to manipulate the three-dimensional model of the exhibit at block 608. For example, the video conferencing service 310 illustrated in FIG. 3 may rotate and translating the three-dimensional model of the exhibit in the three-dimensional environment responsive to the inputs effective to manipulate the three-dimensional model of the exhibit.

The manipulation of the three-dimensional model by the remote video conference participant appearing in two dimensions further contributes to the illusion that the remote video conference participant is presented in three-dimensional video.

In some embodiments, the present technology can also include a meeting director services, that might be an artificial intelligence tool, that is part of the video conferencing service 310 that is configured to utilize virtual cameras to produce a meeting by cutting from panned-out views showing a large portion of the three-dimensional environment, to panned-in views of a close-up of the current speaker. In particular, the meeting director service can aid in providing a more realistic meeting environment when there are three or more meeting participants. The meeting director service can cut to a different camera depending on which speaker is talking to make it appear like the other meeting participants have turned to look at the speaker. In reality, the video of the remote video conference participant is from a straight-ahead view, but the present technology can switch camera views to show different portions of the three-dimensional environment behind the remote video conference participant, which can give the impression that the remote video conference participant has turned to face another conference participant that is currently speaking. In particular, the meeting director service can determine a current speaker, and create a virtual camera for other conference participants where the virtual cameras are located at the location of the speaker in the three-dimensional environment and are pointed at the other participants in the three-dimensional environment respectively. This will cause an effect of showing a new point of view behind the meeting participants.

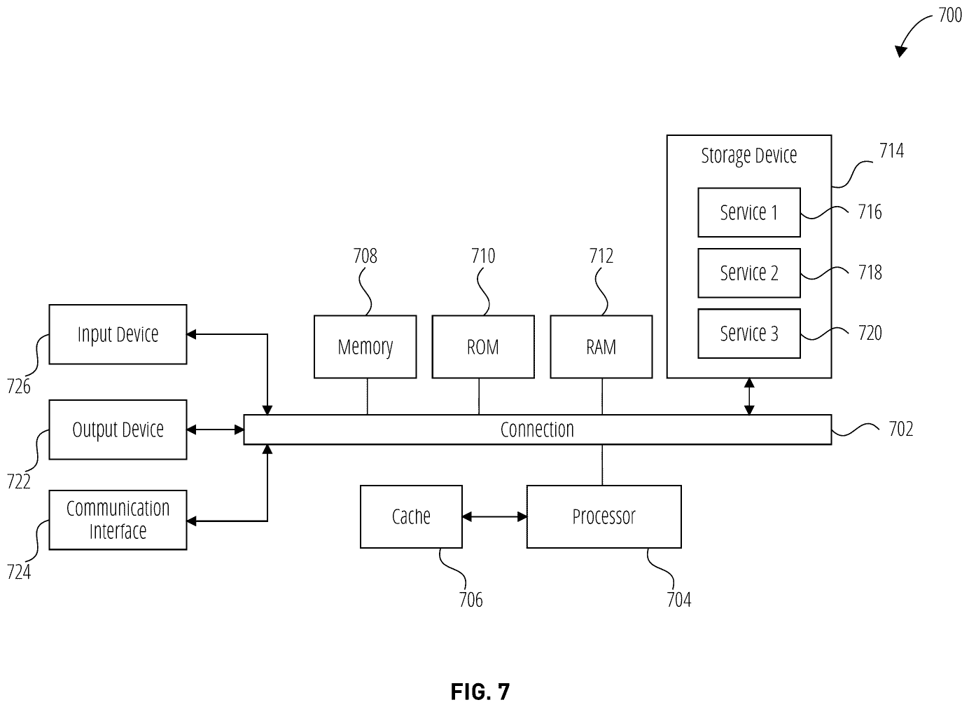

FIG. 7 shows an example of computing system 700, which can be for example any computing device making up remote video conference participant device 308, two-dimensional video display 108, or video conferencing service 310, or any component thereof in which the components of the system are in communication with each other using connection 702. Connection 702 can be a physical connection via a bus, or a direct connection into processor 704, such as in a chipset architecture. Connection 702 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 700 includes at least one processing unit (CPU or processor) 704 and connection 702 that couples various system components including system memory 708, such as read-only memory (ROM) 710 and random access memory (RAM) 712 to processor 704. Computing system 700 can include a cache of high-speed memory 706 connected directly with, in close proximity to, or integrated as part of processor 704.

Processor 704 can include any general purpose processor and a hardware service or software service, such as services 716, 718, and 720 stored in storage device 714, configured to control processor 704 as well as a special-purpose processor where software instructions are incorporated into the actual processor design. Processor 704 may essentially be a completely self-contained computing system, containing multiple cores or processors, a bus, memory controller, cache, etc. A multi-core processor may be symmetric or asymmetric.

To enable user interaction, computing system 700 includes an input device 726, which can represent any number of input mechanisms, such as a microphone for speech, a touch-sensitive screen for gesture or graphical input, keyboard, mouse, motion input, speech, etc. Computing system 700 can also include output device 722, which can be one or more of a number of output mechanisms known to those of skill in the art. In some instances, multimodal systems can enable a user to provide multiple types of input/output to communicate with computing system 700. Computing system 700 can include communication interface 724, which can generally govern and manage the user input and system output. There is no restriction on operating on any particular hardware arrangement, and therefore the basic features here may easily be substituted for improved hardware or firmware arrangements as they are developed.

Storage device 714 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 714 can include software services, servers, services, etc., that when the code that defines such software is executed by the processor 704, it causes the system to perform a function. In some embodiments, a hardware service that performs a particular function can include the software component stored in a computer-readable medium in connection with the necessary hardware components, such as processor 704, connection 702, output device 722, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

The present technology includes computer-readable storage mediums for storing instructions, and systems for executing any one of the methods embodied in the instructions addressed in the aspects of the present technology presented below:

Aspect 1. A method comprising: receiving a video stream including two-dimensional video of a remote video conference participant; rendering a three-dimensional environment by a local video conference participant device for the remote video conference participant based on an analysis of a physical environment of the remote video conference participant; whereby the two-dimensional video of the remote video conference participant appears to a local video conference participant as if it were presented in three-dimensional video.

Aspect 2. The method of Aspect 1, wherein the video stream including the two-dimensional video of the remote video conference participant has been processed by a remote video conference participant device or video conferencing server to remove a background in the two-dimensional video of the remote video conference participant.

Aspect 3. The method of any of Aspects 1 to 2, further comprising: identifying a face or head of a human local video conference participant by the local video conference participant device; and displaying, by the local video conference participant device, the three-dimensional environment relative to a point of view determined from a position of the identified face or head of the human local video conference participant relative to a two-dimensional video display.

Aspect 4. The method of any of Aspects 1 to 3, further comprising: tracking the position of the local video conference participant in a physical environment before the two-dimensional video display, wherein the tracking the position of the local video conference participant includes tracking the face or head of the human local video conference participant as the human local video conference participant moves in the physical environment; and translating the three-dimensional environment in response to a change in the position of the local video conference participant device.

Aspect 5. The method of any of Aspects 1 to 4, wherein the three-dimensional environment is displayed by a two-dimensional video display presented in a frame, the frame is a physical frame that provides depth to the three-dimensional environment and aids in a perception of parallax by the local video conference participant, wherein the two-dimensional video window presented in the frame creates an impression of peering into the three-dimensional environment through window.

Aspect 6. The method of any of Aspects 1 to 5, wherein the three-dimensional environment includes a least one animated element, wherein the three-dimensional environment appears as live video.

Aspect 7. The method of any of Aspects 1 to 6, further comprising: analyzing the two-dimensional video of the remote video conference participant for at least one attribute; adjusting the three-dimensional environment based on the at least one attribute.

Aspect 8. The method of any of Aspects 1 to 7, wherein the at least one attribute pertains to a direction and intensity of a light source illuminating the remote video conference participant, and the adjusting the three-dimensional environment includes adjusting the lighting of the three-dimensional environment to originate from a similar direction and adjusting the three-dimensional environment for a light saturation that appears natural for the intensity of the light source.

Aspect 9. The method of any of Aspects 1 to 8, wherein the at least one attribute pertains to a color temperature illuminating the remote video conference participant, and the adjusting the three-dimensional environment includes adjusting the color temperature of the three-dimensional environment to be more similar to the color temperature illuminating the remote video conference participant.

Aspect 10. The method of any of Aspects 1 to 9, wherein the adjusting the three-dimensional environment includes selecting the three-dimensional environment from a collection of three-dimensional environments that is compatible with the attribute.

Aspect 11. The method of any of Aspects 1 to 10, further comprising: processing the two-dimensional video of the remote video conference participant to appear in three-dimensions.

Aspect 12. The method of any of Aspects 1 to 11, wherein the three-dimensional environment is constructed from a plurality of layers.

Aspect 13. The method of any of Aspects 1 to 12, further comprising: receiving a three-dimensional model of an exhibit; displaying the three-dimensional model of the exhibit in the three-dimensional environment at a location in a foreground relative to the two-dimensional video of the remote video conference participant; receiving inputs effective to manipulate the three-dimensional model of the exhibit; and rotating and translating the three-dimensional model of the exhibit in the three-dimensional environment responsive to the inputs effective to manipulate the three-dimensional model of the exhibit.

What is claimed is:

1. A method comprising:
receiving a video stream including a two-dimensional video of a remote video conference participant;
rendering a three-dimensional environment for the remote video conference participant based on an analysis of a physical environment of the remote video conference participant; and
inserting the two-dimensional video of the remote video conference participant into the three-dimensional environment, whereby the two-dimensional video of the remote video conference participant appears to a local video conference participant as if it were presented in three-dimensional video.

2. The method of claim 1, wherein the video stream including the two-dimensional video of the remote video conference participant has been processed to remove the physical environment in a background in the two-dimensional video of the remote video conference participant.

3. The method of claim 1, further comprising:
identifying a point of view of the local video conference participant; and
displaying the three-dimensional environment relative to the point of view of the local video conference participant relative to a two-dimensional video display.

4. The method of claim 3, further comprising:
tracking a position of the local video conference participant in a physical environment before the two-dimensional video display; and
translating the three-dimensional environment in response to a change in the position of a local video conference participant device in the physical environment.

5. The method of claim 1, wherein the three-dimensional environment includes a least one animated element, wherein the three-dimensional environment appears as live video.

6. The method of claim 1, further comprising:
analyzing the two-dimensional video of the remote video conference participant for at least one attribute; and
adjusting the three-dimensional environment based on the at least one attribute.

7. The method of claim 1, wherein the three-dimensional environment is constructed from a plurality of layers.

8. The method of claim 1, further comprising:
receiving a three-dimensional model of an exhibit;
displaying the three-dimensional model of the exhibit in the three-dimensional environment at a location in a foreground relative to the two-dimensional video of the remote video conference participant;
receiving inputs effective to manipulate the three-dimensional model of the exhibit; and
rotating and translating the three-dimensional model of the exhibit in the three-dimensional environment responsive to the inputs effective to manipulate the three-dimensional model of the exhibit.

9. A computing system comprising:
a processor; and
a memory storing instructions that, when executed by the processor, configure the system to:
receive a video stream including a two-dimensional video of a remote video conference participant;
render a three-dimensional environment for the remote video conference participant based on an analysis of a physical environment of the remote video conference participant; and
insert the two-dimensional video of the remote video conference participant into the three-dimensional environment, whereby the two-dimensional video of the remote video conference participant appears to a local video conference participant as if it were presented in three-dimensional video.

10. The computing system of claim 9, wherein the video stream include the two-dimensional video of the remote video conference participant has been processed to remove a background in the two-dimensional video of the remote video conference participant.

11. The computing system of claim 9, wherein the instructions further configure the system to:
identify a point of view of the local video conference participant; and
display the three-dimensional environment relative to the point of view of the local video conference participant relative to a two-dimensional video display.

12. The computing system of claim 11, wherein the instructions further configure the system to:
track a position of the local video conference participant in a physical environment before the two-dimensional video display; and
translate the three-dimensional environment in response to a change in the position of a local video conference participant device in the physical environment.

13. The computing system of claim 9, wherein the instructions further configure the system to:
analyze the two-dimensional video of the remote video conference participant for at least one attribute; and
adjust the three-dimensional environment based on the at least one attribute.

14. The computing system of claim 9, wherein the instructions further configure the system to:
receive a three-dimensional model of an exhibit;
display the three-dimensional model of the exhibit in the three-dimensional environment at a location in a foreground relative to the two-dimensional video of the remote video conference participant;
receive inputs effective to manipulate the three-dimensional model of the exhibit; and
rotate and translate the three-dimensional model of the exhibit in the three-dimensional environment responsive to the inputs effective to manipulate the three-dimensional model of the exhibit.

15. A non-transitory computer-readable storage medium, the computer-readable storage medium including instructions that when executed by a computer, cause the computer to:
receive a video stream including a two-dimensional video of a remote video conference participant;
render a three-dimensional environment for the remote video conference participant based on an analysis of a physical environment of the remote video conference participant; and
insert the two-dimensional video of the remote video conference participant into the three-dimensional environment, whereby the two-dimensional video of the remote video conference participant appears to a local video conference participant as if it were presented in three-dimensional video.

16. The non-transitory computer-readable storage medium of claim 15, wherein the video stream include the two-dimensional video of the remote video conference participant has been processed to remove a background in the two-dimensional video of the remote video conference participant.

17. The non-transitory computer-readable storage medium of claim 15, wherein the instructions further configure the computer to:
identify a point of view of the local video conference participant; and
display the three-dimensional environment relative to the point of view of the local video conference participant relative to a two-dimensional video display.

18. The non-transitory computer-readable storage medium of claim 17, wherein the instructions further configure the computer to:
track a position of the local video conference participant in a physical environment before the two-dimensional video display; and
translate the three-dimensional environment in response to a change in the position of a local video conference participant device in the physical environment.

19. The non-transitory computer-readable storage medium of claim 15, wherein the three-dimensional environment includes a least one animated element, wherein the three-dimensional environment appears as live video.

20. The non-transitory computer-readable storage medium of claim 15, wherein the instructions further configure the computer to:
analyze the two-dimensional video of the remote video conference participant for at least one attribute; and
adjust the three-dimensional environment based on the at least one attribute.
